(19) United States
(12) Patent Application Publication
(10) Pub. No.: US 2017/0155940 A1
(43) Pub. Date: Jun. 1, 2017

(54) Method For Providing Video Service, Method For Access Authentication, Electronic Device And Non-Transitory Computer-Readable Storage Medium

(71) Applicants: Le Holdings (Beijing) Co., Ltd., Beijing (CN); LeCloud Computing Co., Ltd., Beijing (CN)

(72) Inventors: Zongrui Jin, Beijing (CN); Donghao Wang, Beijing (CN); Junshi Liu, Beijing (CN)

(21) Appl. No.: 15/252,847

(22) Filed: Aug. 31, 2016

Related U.S. Application Data
(63) Continuation of application No. PCT/CN2016/083205, filed on May 24, 2016.

(30) Foreign Application Priority Data
Nov. 27, 2015 (CN) 201510850038.2

(51) Int. Cl. H04N 21/254; H04N 21/61; H04N 21/45; H04N 21/4627; H04N 21/258

(52) U.S. Cl. CPC H04N 21/2541; H04N 21/4627; H04N 21/25883; H04N 21/4532; H04N 21/6125; H04L 67/26

(57) ABSTRACT

Disclosed is a method for providing video service, including receiving by a video server an access request from a client; forwarding the access request to a client server of the client for authentication; receiving an authentication feedback fed back by the client server; and determining whether to provide a video service at least according to the authentication feedback. In addition, the disclosure also provides a method for access authentication, a video server, a client server and a video access system. The disclosure can solve the security hazard of leakage of user information and overload of a video server in the prior art.

### CROSS REFERENCE TO RELATED APPLICATIONS

This application is a continuation of International Application No. PCT/CN2016/083205, filed on 24 May 2016, which is based upon and claims priority to Chinese Patent Application No. 201510850038.2, filed on 27 Nov. 2015, the entire contents of which are incorporated herein by reference.

### TECHNICAL FIELD

The disclosure relates to the technical field of Internet, and in particular to a method for providing video service, a method for access authentication, and an electronic device.

### BACKGROUND

Currently, video service providers provide various video services for clients in such a way that, a client uploads his/her own video resources to a server of a video service provider and has the right to access his/her own videos in the server of the video service provider, or, the client can access videos only possessed by the video service providers through reaching an off-line agreement with the video service provider.

After a client obtains the right to access videos of a server of a video service provider, he/she can authorize its own users to access the videos on the server (video server) of the video service provider, thus the client can provide a better service to his/her own users. For example, considering video service provider (such as LeTV, Youku, or Sohu)—client (such as Jingdong, Dangdang, Taobao, etc.)—user (i.e. end user), when a user of Jingdong wants to view a video about a mobile phone when browsing this mobile phone on Jingdong, Jingdong directly sends a request to access the video of this mobile phone to LeTV. Since there is a standard agreement between Jingdong and LeTV, LeTV will directly provide the requested video for playing. The existing video service providing have problems in that, when a user accesses a video of a video service provider via a client, the access request information package sent may be grabbed by a third party. As such, the third party can use this access request information package to acquire the videos stored in the video server of the video service provider freely, which brings security hazard to the video server of the video service provider, and at the same time also causes stolen playing of client videos.

The method of the prior art is to perform legality authentication on the access request information package in the video server. However, this situation requires the client to upload all his/her user information to the video server of the video service provider and the video server has to provide an authentication service to all clients it serves, which on one hand causes the potential security hazard in user information leakage and on the other hand increases the load of the video server.

### SUMMARY

The disclosure provides a method for providing video service, a method for access authentication, and an electronic device so as to resolve the potential security hazard in leakage of a client's user information and the overload of a video server in the prior art.

According to an aspect of the disclosure, a method for providing video service is provided, including: receiving by a video server an access request from a client; forwarding the access request to a client server of the client for authentication; receiving an authentication feedback from the client server; and determining whether to provide a video service at least according to the authentication feedback.

According to another aspect of the disclosure, there is provided a method for video access authentication including: receiving by a client server an access request from a client forwarded by a video server; generating an authentication feedback according to the access request from the client; and sending the authentication feedback to the video server.

According to still another aspect of the disclosure, there is provided an electronic device, including: at least one processor; and a memory communicably connected with the at least one processor for storing instructions executable by the at least one processor, wherein execution of the instructions by the at least one processor causes the at least one processor to execute the method for providing video service and the method for video access authentication mentioned above.

According to yet another aspect of the disclosure, there is provided a non-transitory computer-readable storage medium storing executable instructions that, when executed by an electronic device, cause the electronic device to execute the method for method for providing video service and the method for video access authentication mentioned above

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for providing video service according to an embodiment of the disclosure;

FIG. 2 is a flowchart of a method for providing video service according to another embodiment of the disclosure;

FIG. 3 is a flowchart of a method for access authentication according to an embodiment of the disclosure;

FIG. 4 is a schematic diagram of a video server according to an embodiment of the disclosure;

FIG. 5 is a schematic diagram of a video server according to an embodiment of the disclosure;

FIG. 6 is a schematic diagram of a client server according to an embodiment of the disclosure; and

FIG. 7 is an architecture diagram of an electronic device or a video access system an embodiment of the disclosure.

### DETAILED DESCRIPTION

In order to make the purpose, technical solutions, and advantages of the embodiments of the invention more clearly, technical solutions of the embodiments of the disclosure will be described clearly and completely in conjunction with the figures. Obviously, the described embodiments are merely part of the embodiments of the disclosure, but not all embodiments. Based on the embodiments of the disclosure, other embodiments obtained by the ordinary skill in the art without inventive efforts are within the scope of the disclosure.

It should be noted that, embodiments of the present application and the technical features involved therein may be combined with each other in case they are not conflict with each other.

The disclosure can be applied in various general or specialized computer system or configuration, such as personal computer, server computer, hand-held device or portable device, tablet device, multi-processor system, microprocessor based system, set top box, programmable consuming electronic device, network PC, small computer, mainframe computer, and distributed computer environment including the above system or devices, etc.

The disclosure can be described in the context of computer executable instructions, such as program module, which can be executed by a computer. Generally, a program module includes routines, procedure, object, assemblies, and data structure, etc. for carrying out specific task or implementing specific abstract data type. The invention can also be implemented in a distributed computer environment in which the task is performed by remote devices connected through communication network. In the distributed computer environment, the program module can be put in a storage mediums including memory device of the local and remote computer.

Finally, it should also be noted that, wordings like first and second are merely for separating one entity or operation from the other, but not intended to require or imply a relation or sequence among these entities or operations. Further, terms like “include”, “including”, and the like are to be construed as including not only the elements described, but also those elements not specifically described, or further including elements which are essential to such process, method, article or device. Unless the context clearly requires, throughout the description and the claims, elements defined by recitation with “including . . . ” should not be construed as exclusive from the process, method, article or device including said elements of other equivalent elements.

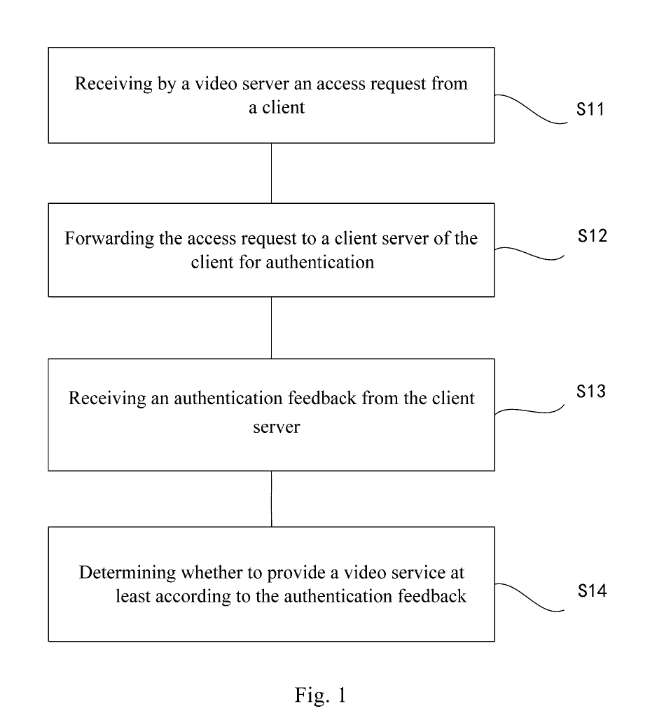

As shown in FIG. 1, a method for providing video service in the disclosure includes:

S11: a video server receives an access request from a client;

S12: the video server forwards the access request to a client server of the client for authentication;

S13: the video server receives an authentication feedback from the client server; and

S14: the video server determines whether to provide a video service at least according to the authentication feedback.

In this embodiment, when receiving an access request from a user, a video server forwards the access request to a client server of a client corresponding to the user for local check rather than checking the access request directly on the local server for which the video server needs to store all user information about the user of the client, which on one hand cause a risk of user information leakage and on the other hand increases the running burden of the video server (since the video server serves more than one client). Through this embodiment, checking is done locally at the client server, which on one hand is helpful to the confidentiality of the user information itself and on the other hand also increases the checking efficiency, thereby improving user experience (since if checking is done at the video server end, it will cause checking queuing due to the large traffic, and the real-time experience of user access will be affected badly due to long time checking queuing).

In addition, the problem of the existing method for providing video service lies in that when a user accesses a video of a video service provider via a client, the access request information package sent may be grabbed by a third party, and once being grabbed by a third party, and the third party can use this access request information package to acquire the videos stored in the video server of the video service provider freely, which brings security hazards to the video server of the video service provider, and at the same time also causes stolen playing of client videos. This embodiment, however, avoids the stolen of access request information package by means of the checking of the client server according to user information.

In this embodiment, forwarding the access request to a client server of the client for authentication includes: the video server determining a domain name corresponding to the access request according to the access request; the video server determining the address of a client server corresponding to the client which sends the access request according to the correlation between a pre-stored client server address and the domain name of the client server.

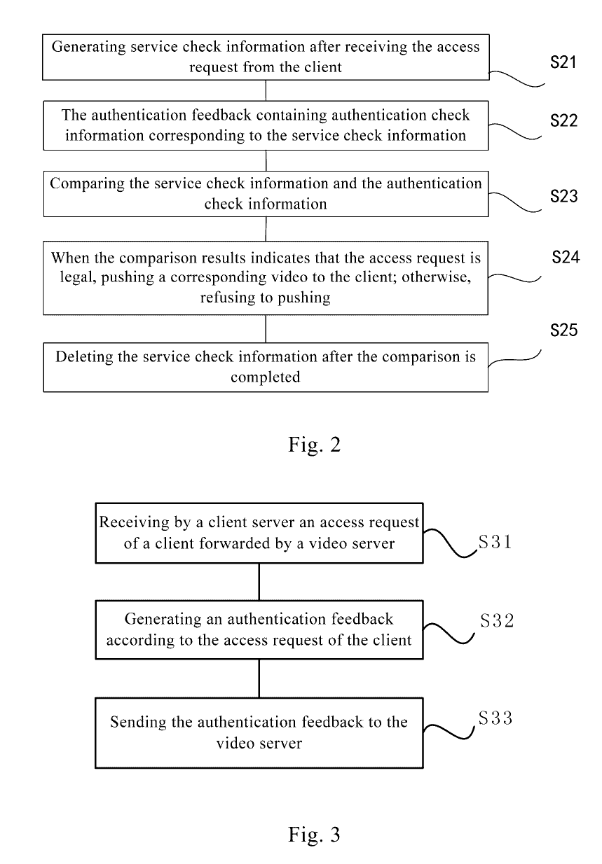

As shown in FIG. 2, in some embodiments, the following steps may be further included.

S21: After receiving an access request from a client, the video server generating service check information;

S22: An authentication feedback is generated which contains authentication check information corresponding to the service check information;

S23: The video server determines whether to provide a video service at least according to the authentication feedback by comparing the service check information and the authentication check information.

S24: The video server pushes video information corresponding to the access request to the client when the comparison result indicates that the access request is a legal request; and the video server refuses to push video information corresponding to the access request to the client when the comparison result indicates that the access request is an illegal request.

S25: The video server deletes the service check information after the comparison is completed.

In this embodiment, by means of setting up a preset rule between a video server and a client server, service check information is generated at the video server and corresponding authentication check information is generated at the client server respectively according to the preset rule and the service check information is deleted immediately after the authentication check information is fed back to the video server, thus guaranteeing the validity of the feedback information sent from the client server to the video server.

The preset rule in this embodiment can be a preset mapping table or a rule which makes authentication check information and service check information correspond to each other one by one, such that the access request can be determined as a legal request when it is compared that the authentication check information and the service check information correspond to each other according to the preset rule. For example, the video server can number all the clients thereof from 1 and store same, in which the number is equivalent to service check information, and set up a rule: when the number (i.e. service check information) is n, the corresponding authentication check information is n², at this moment, when comparing the service check information and the authentication check information, as long as they satisfy this rule, the corresponding access request is a legal request. Of course, the preset rule is not limited to the above-mentioned example in this embodiment, a simpler preset rule can be defined as required or a preset rule the calculation of which is more complex can be defined, and the preset rule can be changed regularly as required, so as to prevent the package from being grabbed by a grabber who gets the rule due to a long period use without changing the rule.

Since in this embodiment, the preset rule is stored in the client server and the video server, being isolated from the outside, the service check information and the authentication information generated correspondingly are also unique and cannot be acquired from the outside. On the other hand, since the service check information will be deleted after each check of the video server is completed, it ensures that the stolen playing of a video is avoided even though the feedback information fed back by the client server to the video server is grabbed. This is because there is no corresponding service check information in the video server and then the grabbed information is invalid. In addition, due to the mechanism of generating check information in real time and deleting service check information in real time, the storage burden of the video server is reduced, and the time for selecting correct service check information when performing checking is also reduced, thus improving user experience.

As shown in FIG. 3, in some embodiments, a method for access authentication is provided, which includes the following steps.

S31: A client server receives an access request from a client forwarded by a video server.

S32: The client server generates an authentication feedback according to the access request from the client.

S33: The client server sends the authentication feedback to the video server.

In this embodiment, the client server receives an access request from a client forwarded by a video server for checking rather than checking the access request directly at the video server. If checking is to be performed at the video server, all user information about the user of the client needs to be stored, which on one hand causes the security hazard of user information leakage and on the other hand increases the running burden of the video server (because the video server serves more than one client). By means of this embodiment, checking is done locally at the client server, which on one hand is helpful to keeping the confidentiality of the user information of its own user and on the other hand also increases the checking efficiency, thus improving user experience (since if checking is done at the video server end, it will cause checking queuing due to the large traffic, and the real-time experience of user access will be affected badly due to long time checking queuing).

In addition, the existing method for providing video service has a problem that when a user accesses a video of a video service provider via a client, the access request information package may be grabbed by a third party. Once being grabbed by a third party, this access request information package may be used by the third party to acquire the videos stored in the video server of the video service provider freely, which causes security hazard to the video server of the video service provider and stolen playing of client videos. This embodiment can prevent occurrence of access request information package from being stolen through checking the client server according to user information.

In some embodiments, the authentication feedback contains authentication check information which corresponds to the service check information generated after the video server receives the access request from the client.

In this embodiment, by setting up a preset rule between a video server and a client server, service check information is generated at the video server and corresponding authentication check information is generated at the client server respectively according to the preset rule and the service check information is deleted immediately after the authentication check information is fed back to the video server, thus realizing the guarantee of the validity of the feedback information sent from the client server to the video server.

Since in this embodiment, the preset rule is stored in the client server and the video server, being isolated from the outside, the service check information and the authentication information generated correspondingly are also unique and cannot be acquired from the outside. On the other hand, since the service check information will be deleted after each check of the video server is completed, it ensures that the stolen playing of a video is avoided even though the feedback information fed back by the client server to the video server is grabbed, this is because there is no corresponding service check information in the video server and then the grabbed information is invalid. In addition, due to the mechanism of generating check information in real time and deleting service check information in real time, the storage burden of the video server is reduced, and the time for selecting correct service check information when performing checking is also reduced, thus improving user experience.

In the embodiments of the disclosure, the relevant functional modules can be realized by means of a hardware processor.

It needs to be noted that, all method embodiments mentioned above are expressed as merging of a series of operations for the sake of simple description. However, those skilled in the art can know that the disclosure is not limited to the order of the described operations, since some steps can employ other orders or can be performed simultaneously according to the disclosure. Secondly, those skilled in the art shall also know that the embodiments described in the description are all preferred embodiments, and the related operations and modules may not be fully necessary to the disclosure.

In the above-mentioned embodiments, the description of each embodiment is different, and the portion which is not described in detail in certain embodiment can refer to relevant description of other embodiments.

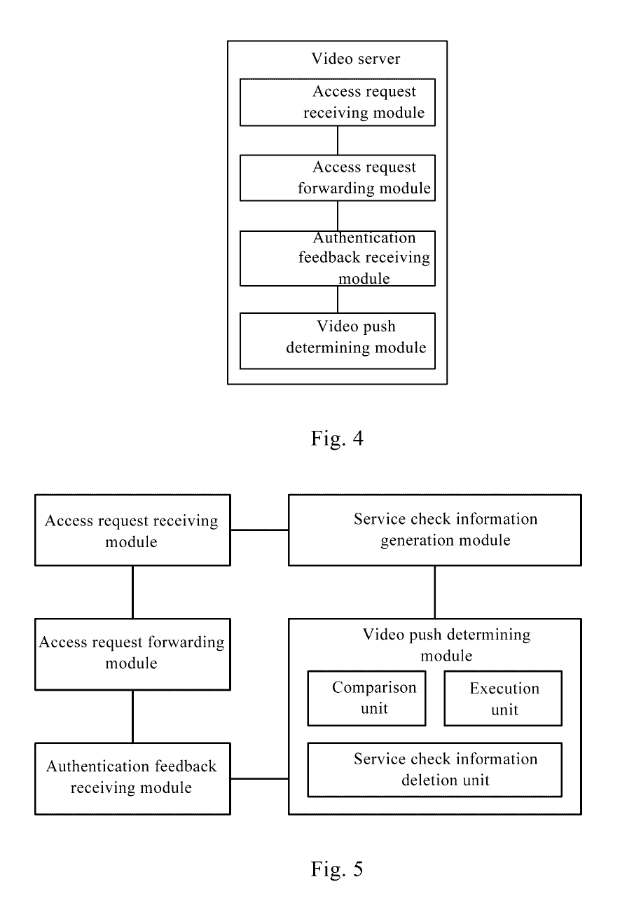

As shown in FIG. 4, in another aspect, the disclosure also provides a video server including:

an access request receiving module for receiving an access request from a client;

an access request forwarding module for forwarding the access request to a client server of the client for authentication;

an authentication feedback receiving module for receiving an authentication feedback fed back by the client server; and

a video push determining module for determining whether to provide a video service at least according to the authentication feedback.

In this embodiment, when receiving an access request from a user via an access request receiving module, a video server forwards the access request to a client server of a client corresponding to the user for local check via an access request forwarding module rather than checking the access request directly on the local server which needs the video server to store all user information about the user of the client for performing checking and thus on one hand has a risk of user information leakage and on the other hand increases the running burden of the video server (since the video server serves more than one client) By means of this embodiment, checking is done locally at the client server, which on one hand is helpful to the confidentiality of the user information itself and on the other hand also increases the checking efficiency, thus improving user experience (since if checking is done at the video server end, checking queuing will be rendered due to the large traffic, and the real-time experience of user access will be affected badly due to long time checking queuing).

In this embodiment, the video server is a server or server cluster, in which each module can be a single server or server cluster, and at this moment, the interaction among the above-mentioned modules manifests as the interaction among the servers or server clusters corresponding to various modules, and a plurality of servers or server clusters constitute the video server in the disclosure. In particular, the video server in this embodiment includes:

an access request receiving server or server cluster for receiving an access request from a client;

an access request forwarding server or server cluster for forwarding the access request to a client server of the client for authentication;

an authentication feedback receiving server or server cluster for receiving an authentication feedback from the client server; and

a video push determining server or server cluster for determining whether to provide a video service at least according to the authentication feedback.

As shown in FIG. 5, in some embodiments of the disclosure, a video server may include:

a service check information generation module for generating service check information after the access request receiving module receives an access request from a client;

an authentication feedback receiving module for receiving the authentication feedback which contains authentication check information corresponding to the service check information; and

a video push determining module that includes:

a comparison unit for comparing the service check information and the authentication check information;

an execution unit for pushing video information corresponding to the access request to the client when the comparison result indicates that the access request is a legal request; and refusing to push video information corresponding to the access request to the client when the comparison result indicates that the access request is an illegal request; and

a service check information deletion unit for deleting the check information after the comparison unit completes comparison.

In this embodiment, by setting up a preset rule between a video server and a client server, service check information is generated at the video server and corresponding authentication check information is generated at the client server respectively according to the preset rule, and the service check information is deleted immediately after the authentication check information is fed back to the video server, thus guaranteeing the validity of the feedback information sent from the client server to the video server.

In this embodiment, the service check information generation module, the authentication feedback receiving module and the video push determining module may be implemented respectively by a server or server cluster, and each module can be a single server or server cluster. In this case, the interaction among the above-mentioned modules manifests as the interaction among the servers or server clusters corresponding to various modules.

In an alternative embodiment, several modules can constitute a server or server cluster. For example, the service check information generation module and the authentication feedback receiving module constitute a first server or first server cluster, and the video push determining module constitutes a second server or second server cluster.

In another alternative embodiment, the video push determining module is a server or server cluster, in which the comparison unit, the execution unit and the service check information deletion unit can be a single server or server cluster, and at this moment, interactions among the above-mentioned units will be interactions among the servers or server clusters corresponding to various units.

In an alternative embodiment, several modules in the above-mentioned plurality of modules can constitute a server or server cluster. For example, the comparison unit, the execution unit and the service check information deletion unit may constitute a first server or first server cluster.

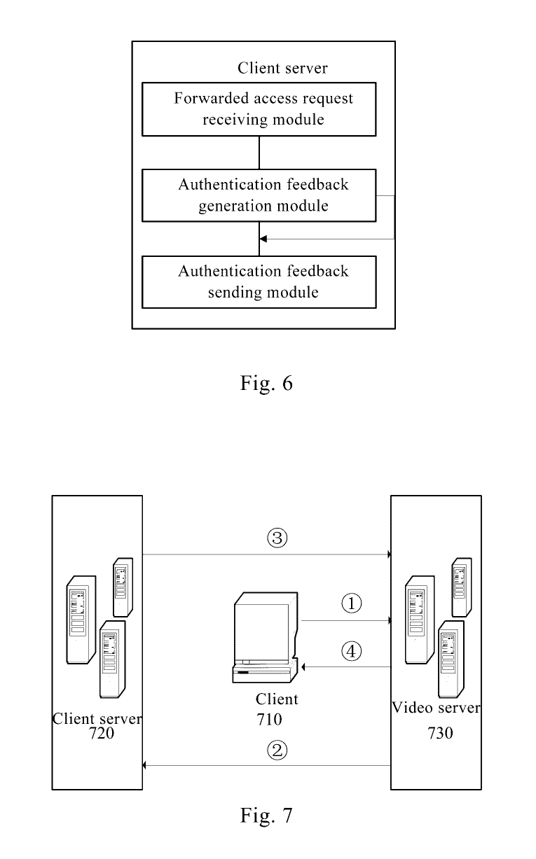

As shown in FIG. 6, in some embodiments of the disclosure, a client server includes:

a forwarded access request receiving module for receiving an access request from a client forwarded by a video server;

an authentication feedback generation module for generating an authentication feedback according to the access request from the client; and

an authentication feedback sending module for sending the authentication feedback to the video server.

In this embodiment, a client server receives an access request from a client forwarded by a video server for checking, so that the access request will not be directly checked on the video server. Since checking on the video server directly requires all user information about the user of the client to be stored in the video server, which on one hand has the risk of user information leakage and on the other hand increases the running burden of the video server (since the video server serves more than one client). According to this embodiment, checking is done locally at the client server, which on one hand is helpful to keeping the confidentiality of the user information itself and on the other hand also increases the checking efficiency, improving user experience (since if checking is done at the video server end, a checking queuing will be formed due to the large traffic, and the real-time experience of user access will be affected badly due to long time checking queuing).

In this embodiment, the client server may be a server or server cluster, in which each module can be a single server or server cluster, and at this moment, the interaction among the above-mentioned modules manifests as the interaction among the servers or server clusters corresponding to various modules, and a plurality of servers or server clusters constitute the client server in the disclosure.

In particular, the client server in the embodiment includes:

a forwarded access request receiving server or server cluster for receiving an access request from a client forwarded by a video server;

an authentication feedback generation server or server cluster for generating an authentication feedback according to the access request from the client; and

an authentication feedback sending server or server cluster for sending the authentication feedback to the video server.

In an alternative embodiment, several modules in the above-mentioned plurality of modules can constitute a server or server cluster. For example, the authentication feedback generation module and the authentication feedback sending module constitute a first server or first server cluster, and the forwarded access request receiving module constitutes a second server or second server cluster.

In some embodiments, the authentication feedback contains authentication check information corresponding to service check information generated after the video server receives the access request from the client.

In another aspect, the disclosure also provides an electronic device or a video access system, including a video server in any above-mentioned embodiment and a client server in any above-mentioned embodiment.

FIG. 7 shows an architecture diagram of an electronic device or a video access system according to an embodiment of the disclosure, which includes a client 710, a client server 720 and a video server 730, in which the client 710 and the client server 720 are communicatively connected to the video server 730 respectively. In the video access system in this embodiment, the following execution steps are included:

1) the client 710 sends an access request to the video server 730;

2) after receiving the access request from the client 710, the video server 730 generates service check information and forwards the access request to the client server 720 for authentication;

3) after receiving the access request forwarded by the video server 730, the client server 720 generates an authentication feedback according to the access request from the client and sends the authentication feedback to the video server 730; and

4) the video server 730 determines whether to provide a video service at least according to the authentication feedback.

In this embodiment, the access request can be directly generated by the client or can be fed back to the client after being generated by the client server.

In another embodiment, the access request from the client is generated by the client server and sent to the video server by the client server.

In this embodiment, the client server 720 executes the video authentication method as shown in FIG. 3.

The video server 730 executes the method for providing video service as shown in FIG. 1.

By means of the method for providing video service, the method for access authentication, the server and the system provided in the embodiments of the disclosure, when receiving an access request from a user, a video server forwards the access request to a client server of a client corresponding to the user for local check rather than checking the access request directly on the local server, thus the video server need not to store all user information about the users of the client for checking, which reduces the risk of user information leakage and relieves the running burden of the video server.

The foregoing embodiments of device are merely illustrative, in which those units described as separate parts may or may not be separated physically. Displaying part may or may not be a physical unit, i.e., may locate in one place or distributed in several parts of a network. Some or all modules may be selected according to practical requirement to realize the purpose of the embodiments, and such embodiments can be understood and implemented by the skilled person in the art without inventive effort.

A person skilled in the art can clearly understand from the above description of embodiments that these embodiments can be implemented through software in conjunction with general-purpose hardware, or directly through hardware. Based on such understanding, the essence of foregoing technical solutions, or those features making contribution to the prior art may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

It would be appreciated by the skilled in the art that, the embodiments of the disclosure can be provided as method, system, or computer program product. Therefore, the disclosure can be implemented in various ways, such as purely by hardware, or purely by software, or a combination of software and hardware. Moreover, the disclosure can be implemented as a computer program product including one or more computer executable program codes which are stored on a computer readable memory medium (including but not limited to a disk storage or optic memory, etc.).

The disclosure is described in reference to method, device (or system), and flow chart and/or block diagram of computer program product of embodiment of the invention. It should be understood that each flow and/or block and a combination thereof in a flow chart and/or block diagram can be implemented by computer program instruction. These computer program instruction can be provided to a universal computer, a dedicated computer, an embedded processor or a processor of other programmable data processing device to generate a machine, so that a device capable of realizing functions designated by one or more flows of a flow chart and/or one or more blocks of a block diagram can be generated through execution of instructions by a computer or processor of other programmable data processing device.

These computer program instructions may be stored in a computer readable memory which can guide the computer or other programmable data processing device to operate in a special way, so that the instruction stored in the computer readable memory generates a product including an instruction device which carries out functions designated by one or more flows of a flow chart and/or one or more blocks of a block diagram. These computer program instructions can also be loaded on a computer or other programmable data processing device so as to enable a series of operations to be carried out on the computer or other programmable device to realize processing of the computer, thus providing operations for achieving functions designated by one or more flows of a flow chart and/or one or more blocks of a block diagram by the instructions executed by the computer or other programmable device.

Finally, it should be noted that, the above embodiments are merely provided for describing the technical solutions of the disclosure, but not intended as a limitation. Although the disclosure has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the disclosure.

What is claimed is:

1. A method for providing video service, comprising, at a video server:
receiving an access request from a client;
forwarding the access request to a client server of the client for authentication;
receiving an authentication feedback from the client server; and
determining whether to provide a video service at least according to the authentication feedback.

2. The method for providing video service according to claim 1, wherein
after receiving an access request from a client, a service check information is generated;
the authentication feedback comprises authentication check information corresponding to the service check information; and
said determining whether to provide a video service at least according to the authentication feedback comprises, at the video server:
comparing the authentication check information and the service check information;
pushing video information corresponding to the access request to the client when the comparison result indicates that the access request is a legal request; and refusing to push video information corresponding to the access request to the client when the comparison result indicates that the access request is an illegal request; and
deleting the service check information after the comparison is completed.

3. A method for access authentication comprising, at a client server:
receiving an access request from a client forwarded by a video server;
generating an authentication feedback according to the access request from the client; and
sending the authentication feedback to the video server.

4. The method for access authentication according to claim 3, wherein the authentication feedback comprises authentication check information corresponding to service check information generated after the video server receives the access request from the client.

5. An electronic device, comprising:
at least one processor; and
a memory communicably connected with the at least one processor for storing instructions executable by the at least one processor, wherein execution of the instructions by the at least one processor causes the at least one processor to:
receive an access request from a client;
forward the access request to a client server of the client for authentication;
receive an authentication feedback from the client server; and
determine whether to provide a video service at least according to the authentication feedback;
or
receive an access request from a client forwarded by a video server;
generate an authentication feedback according to the access request from the client; and
send the authentication feedback to the video server.

6. The electronic device according to claim 5, wherein execution of the instructions by the at least one processor further causes the at least one processor to generate service check information after receiving an access request from a client, and wherein
the authentication feedback comprises authentication check information corresponding to the service check information; and
execution of the instructions by the at least one processor further causes the at least one processor to:
compare the service check information and the authentication check information;
push video information corresponding to the access request to the client when the comparison result indicates that the access request is a legal request; and refuse to push video information corresponding to the access request to the client when the comparison result indicates that the access request is an illegal request; and
delete the check information after the comparison unit completes comparison.

7. The electronic device according to claim 6, wherein the authentication feedback comprises authentication check information corresponding to service check information generated after the video server receives the access request from the client.

8. A non-transitory computer-readable storage medium storing executable instructions that, when executed by an electronic device, cause the electronic device to:
receive an access request from a client;
forward the access request to a client server of the client for authentication;
receive an authentication feedback from the client server; and
determine whether to provide a video service at least according to the authentication feedback.

9. The non-transitory computer-readable storage medium according to claim 8, wherein execution of the instructions by the electronic device further causes the electronic device to generate service check information after receiving an access request from a client, and wherein
the authentication feedback comprises authentication check information corresponding to the service check information; and
execution of the instructions by the electronic device further causes the electronic device to:
compare the service check information and the authentication check information;
push video information corresponding to the access request to the client when the comparison result indicates that the access request is a legal request; and refuse to push video information corresponding to the access request to the client when the comparison result indicates that the access request is an illegal request; and
delete the check information after the comparison unit completes comparison.

10. The non-transitory computer-readable storage medium according to claim 8, wherein execution of the instructions by the electronic device further causes the electronic device to:
receive an access request from a client forwarded by a video server;
generate an authentication feedback according to the access request from the client; and
send the authentication feedback to the video server.

11. The non-transitory computer-readable storage medium according to claim 10, wherein the authentication feedback comprises authentication check information corresponding to service check information generated after the video server receives the access request from the client.
